(19) United States
(12) Patent Application Publication
(10) Pub. No.: US 2015/0023797 A1
(43) Pub. Date: Jan. 22, 2015

(54) Aerodynamic Variable Cross-Section Airfoil and Constant Lateral Surface Area Truss

(71) Applicant: Nitin Kitchley Egbert, San Jose, CA (US)

(72) Inventor: Nitin Kitchley Egbert, San Jose, CA (US)

(21) Appl. No.: 13/942,708

(22) Filed: Jul. 16, 2013

(51) Int. Cl. F15D 1/12; B64C 3/14; B63B 1/24

(52) U.S. Cl. CPC F15D 1/12; B63B 1/248; B64C 3/14
USPC 416/223 R

(57) ABSTRACT

The invention provides a mechanism for an airtight airfoil with variable cross section that can lower its average density below that of the medium in which it is used, providing additional bouyancy and reducing the effective weight of any craft to which it may be affixed. The outside of the airfoil is formed by a sheet of material that is impermeable to the medium in which the foil is used. This sheet is affixed to several points on an internal expandable frame. The cross-sectional perimeter of the frame remains constant throughout the expansion of the frame, minimizing wear on the enclosing sheet of material. Because the length of the sheet remains constant through the expansion process, the sheet need not be elastic, and may even be replaced by rigid plates of material. By providing a variable source of buoyancy, this foil enables lower speed and lower power applications than regular foils. By providing a smoothly variable airfoil cross-section, this foil enables higher performance in a wider variety of aerodynamic conditions.

### CROSS-REFERENCES TO RELATED APPLICATIONS

U.S. Pat. No. 5,005,783—Taylor

U.S. Pat. No. 1,424,491—Langevin

U.S. Pat. No. 3,970,270—Pittet

### FIELD OF INVENTION

This invention relates to methods of reducing the effective weight or increasing the buoyancy of any vehicle or craft that requires an airfoil or hydrofoil, as well as applications that require dynamic changes in the cross-section of an airfoil or hydrofoil.

### BACKGROUND OF INVENTION

In recent years there has been an increase in military and commercial interest in small, lightweight aircraft. Making such aircraft lighter-than-air is often undesirable because it increases the need for maintenance as the source of the buoyancy is often a bladder or balloon filled with a lighter-than-air gas, which when exposed to stress can tear or burst unpredictably and lose its utility. On the other hand, making such a craft only partially buoyant as an auxiliary form of support, rather than its only means of lift, can be helpful, and facilitate lower power use on average. This has been proposed before.

This invention proposes a novel means of using the airfoil of the craft itself as a chamber of variable buoyancy. A puncture or tear in this chamber does not spell doom for the aircraft, since the overall shape of the airfoil remains intact, and can still provide some lift or enable the craft to glide to a reasonably safe landing. With the provision of a secondary source of lift not related to airflow, a craft with more than one such airfoil also has a secondary means of control by asymmetrically varying the buoyancy of its foils. This may also aid in certain aerial maneuvers such as escaping a stall.

The invention also provides a means of smoothly varying the shape of the cross-section of the airfoil. Symmetric and asymmetric variations of the shape of the cross-section may also aid in flight of aircraft which experience a wide range of aerodynamic conditions, such as trans-sonic aircraft or aircraft meant to withstand heavy weather conditions.

### SUMMARY OF THE INVENTION

There are many ways to make a useful chamber of variable buoyancy, but all involve a structure that can increase in volume. This could be accomplished by covering an expanding truss with an elastic material, but this is inefficient because to increase the buoyancy, work must be done against both environmental pressure and the elastic material. A chamber of variable buoyancy could also be made by a balloon of non-elastic material which is then folded or tied down to reduce the volume, but this is by necessity not aerodynamically efficient in one of the given configurations, and a misfold or an unexpected wrinkling of the material will severely impair performance.

The ideal solution is to make a chamber of variable buoyancy with a non-elastic material that does not fold to reduce volume. The simplest way to do this is by creating a truss that can change the volume it encloses without appreciably changing the surface area required to cover it, or skew points on its surface in such a way that a non-elastic material that covered it would tear as it changed its volume. The simplest way to achieve this is to make flat planar trusses that can expand in area without changing their perimeter, and then stack these planar trusses, and couple their expansion. This produces a polygonal prism frame with the cross section of an individual truss, whose lateral surface area is constant.

This invention provides several such implementations of a variable buoyancy chamber that can also be used as an airfoil due to its shape and maintenance of favorable aerodynamic properties at every possible configuration. The basic structure need not be used merely to change buoyancy, it may be used for any purpose where the cross section of an airfoil must vary in shape.

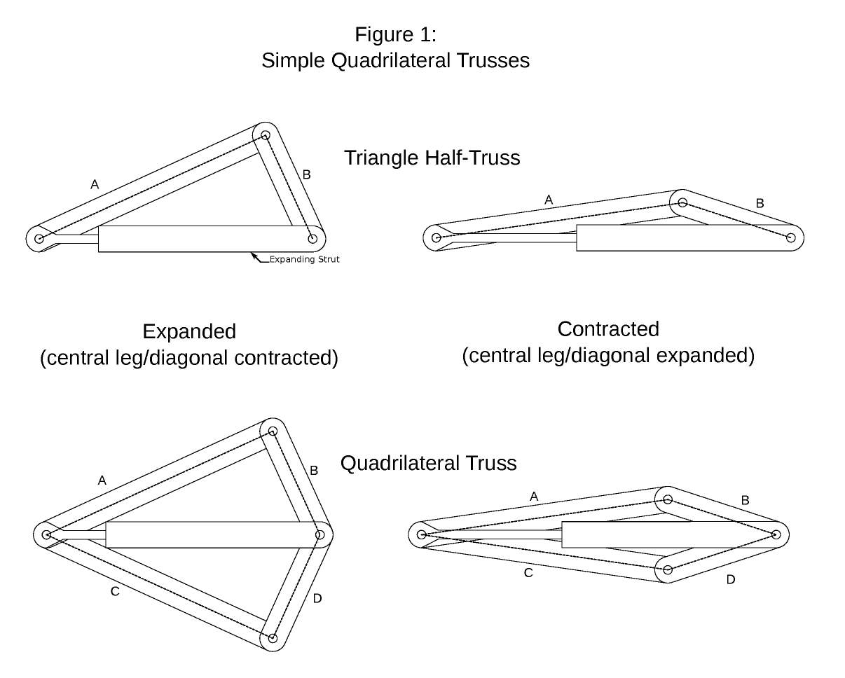

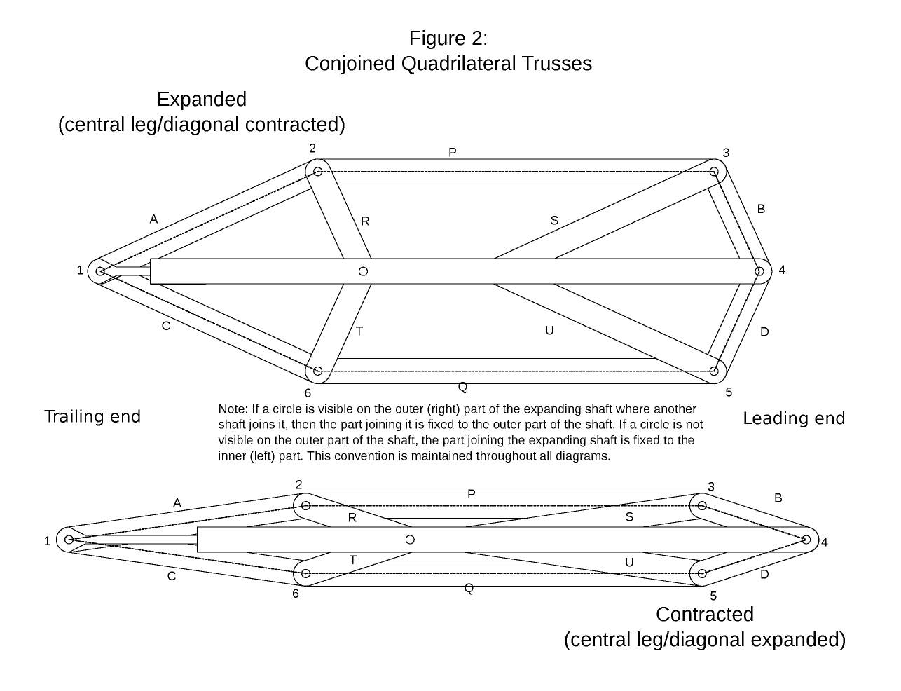

The invention starts from the simple geometric principle that you can reduce the area of a triangular structure by increasing the length of one side and keeping the other two sides fixed. In a real, physical triangular structure of this sort with pivoting shafts, the principle still holds for the two lines connecting the centers of the pivots on the triangle. Such a structure is schematized in the top structure in FIG. 1, the dotted line showing the path that does not change length as the bottom side expands. The dotted line shown through the central axes of the triangle's fixed sides does not change its length as the bottom leg of the triangle expands. This property holds for any jointed pair of rigid struts attached to an expandable strut as in FIG. 1. This structure alone does not maintain a constant perimeter when contracting, but building a quadrilateral that consists of two such triangles that share the expanding side creates a structure that can change its area without changing its perimeter as shown in the bottom structure in FIG. 1. The structure can be generalized further by building two such quadrilaterals (as shown in FIG. 2), coupling their expanding diagonals so that they are forced to expand by the same amount (shown as a single expanding segment from points 1 to 4 in FIG. 2), and attaching the two joints between non expanding sides on one quadrilateral to the corresponding joints on the other quadrilateral (as joints 2 and 3 are attached by segment P and joints 5 and 6 are attached by segment Q in FIG. 2). The entire perimeter of the structure, shown as a dotted line in FIG. 2, does not change as the diagonals of the quadrilaterals change.

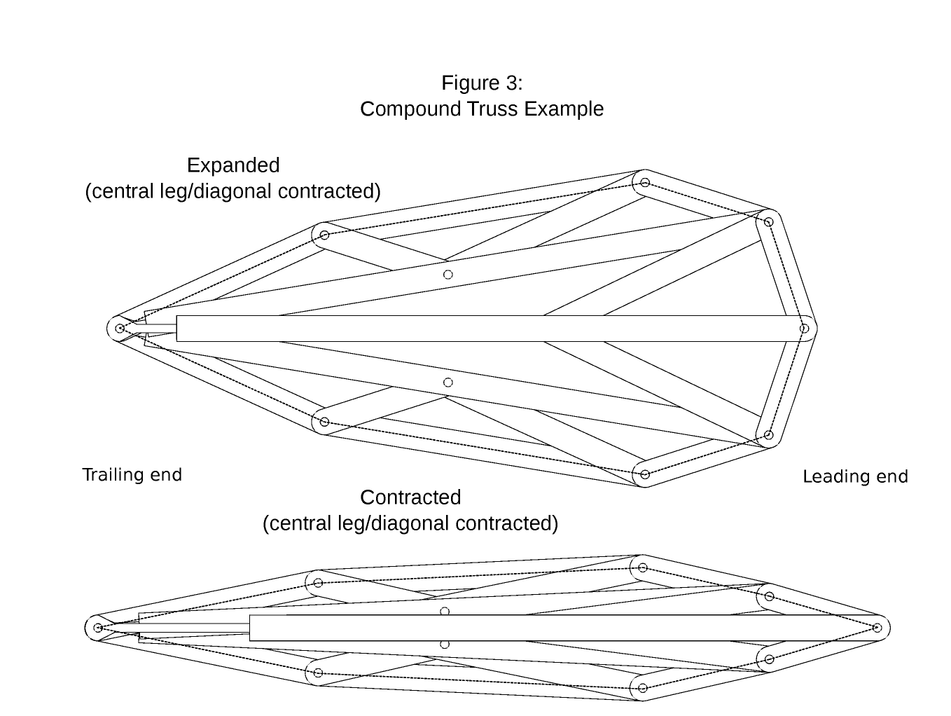

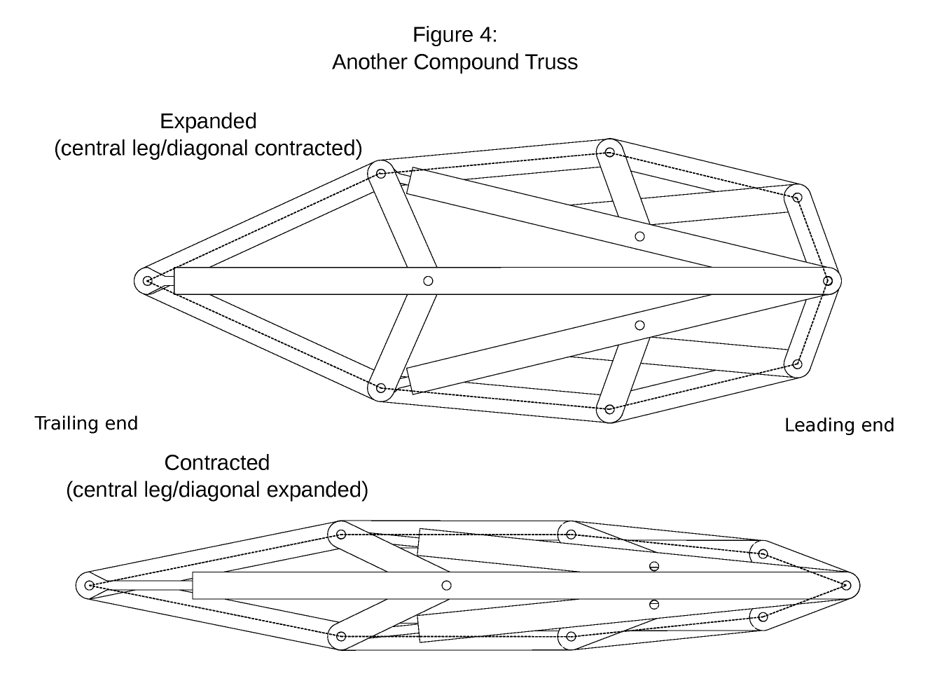

This basic structure formed by jointed rigid struts affixed to expandable struts can be generalized even further. Note that in FIG. 2, removing segments C, T, Q, U and D creates a structure that reduces its area upon expansion of one side, while keeping the length of all other sides constant. In fact, in all of the trusses described thus far, removing the moving parts on one side of the expanding diagonal creates such a structure. I will refer to a structure with this property as a half-truss. If segments A, R and P are removed in the structure in FIG. 2, and another half-truss is placed between points 1 and 3, the whole structure's perimeter does not change upon expansion. The same can be done with segments C, T and Q and points 1 and 5. This yields a structure as in FIG. 3. Alternatively segments P, S, B, Q, U, and D may be removed, and points 2 and 4 and points 6 and 4 may be connected with two half-trusses. This yields a structure as in FIG. 4. The dotted lines in FIGS. 3 and 4 again show the perimeter that remains unchanged. Alternatively, the truss in FIG. 2 can be constructed out of two noncongruent quadrilaterals, and the outer vertices of the quadrilaterals may be joined by half trusses. In fact, half-trusses can be used to replace all but one expanding side of any expanding structure with only one internal degree of freedom to create a new half-truss. A viable half-truss can be built by creating an expanding shaft with any number of not-necessarily congruent pairs of jointed rigid stuctures on it (consisting of two shafts or rods attached at a pivot point with one shaft fixed in position with respect to one side of the expanding shaft, and the other shaft fixed in position with respect to the other side of the expanding shaft) and placing other half-trusses between the pivoting vertices of the expanding triangles.

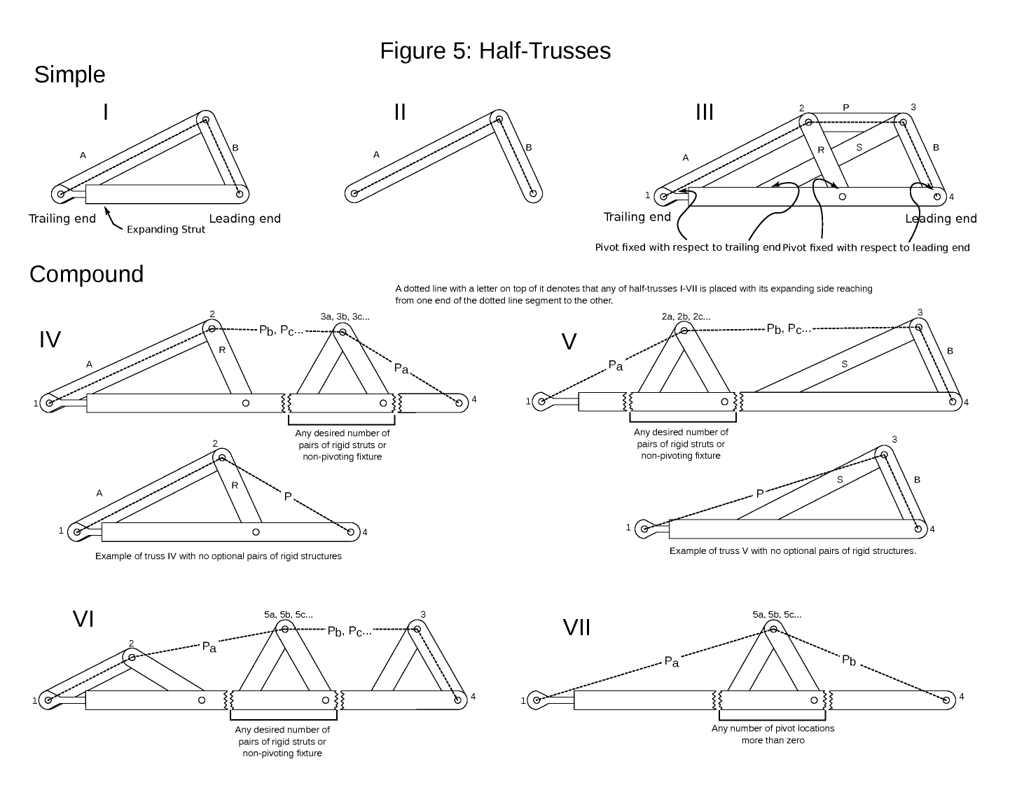

All half trusses described thus far are shown by FIG. 5. The general full truss that establishes the cross-section of an airfoil may be constructed by taking any two half-trusses, mirroring one of them, and constructing them so as to share the expanding side. There is also no reason to build only symmetric airfoils as we have thus far. As long as the two half trusses are constructed to have the same length of expanding side over some range of their motion, a valid full truss can be built by making them share the expanding side. It is best to construct the half trusses so that their expanding sides have the same range of motion for maximum variation in volume. Also note that the simple triangle half-truss does not actually need the expanding shaft on its expanding side to work properly. This has been illustrated in FIG. 5 by including truss II, a separate triangle half-truss with no expanding shaft.

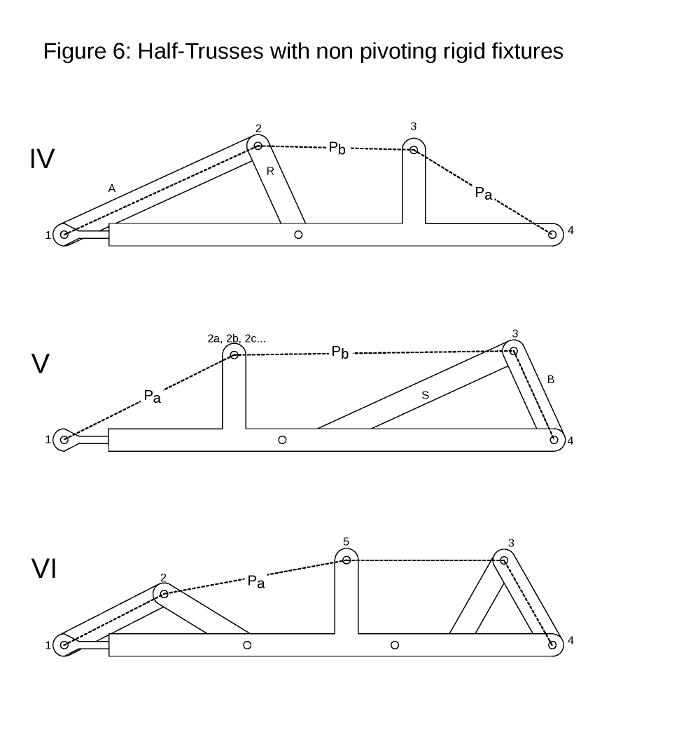

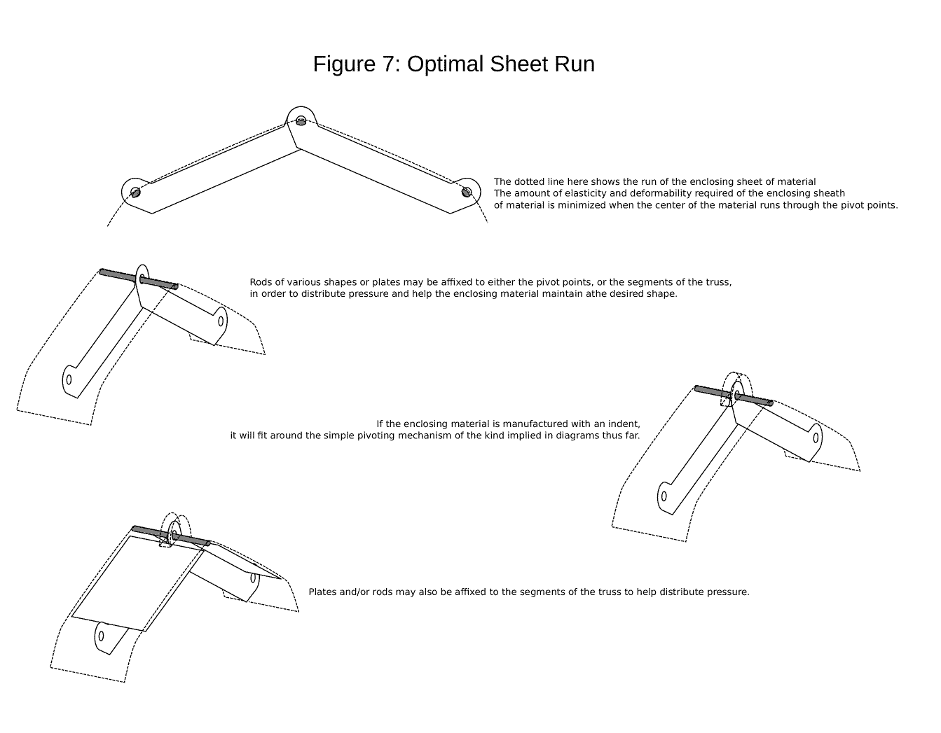

With this amount of variation, it is possible to create an expanding truss that very nearly mimics the cross section of any desired airfoil, and does not change its perimeter as it expands. The truss maintains its properties as long as the length between each of its vertices is fixed. This need not be done with straight shafts as have been shown in diagrams thus far, it may be done with curved segments as shown in FIG. 7, or oddly shaped pieces of material, as long as the pivot points share the same relations described in the other trusses. The perimeter of the truss may be defined as a set of curved paths, where each path in the set shares its endpoints with each external segment of the truss. The length need not even be held fixed with solid supports in some segments, it may be done by a taut cable or wire or other flexible fixed-length support, or the segments may be removed entirely, with the geometry of the rest of the truss working to hold the length fixed. In half-truss III (FIG. 5), any one of segments A, B, R, S, or P may be removed or replaced with a fixed-length flexible support, but no more than one of those segments. The exception to this is if P has been replaced with a fixed-length flexible support, either of segments A and B may be also removed or replaced by fixed-length flexible supports without changing the properties of the truss or significantly impairing performance of the airfoil as long as it is subject to outside pressure. Any of these alterations may also be made to half-truss III when substituting it in one of the compound trusses described. Also, note that removing segment R is equivalent to substituting half-truss II in half-truss V with no optional expanding triangles, and removing segment S is equivalent to substituting half-truss II in half-truss IV. Any of the optional pairs of jointed rigid struts shown in FIG. 5 may also be replaced with just one non-pivoting fixture that is attached to either the leading or trailing edge of the expanding shaft. This is exemplified in FIG. 6. Note that any of the compound half-trusses in FIG. 5 may be designed so that some of the lines labeled with a P may actually contract, while others expand. This gives more variability to the shape of the cross-section of the truss.

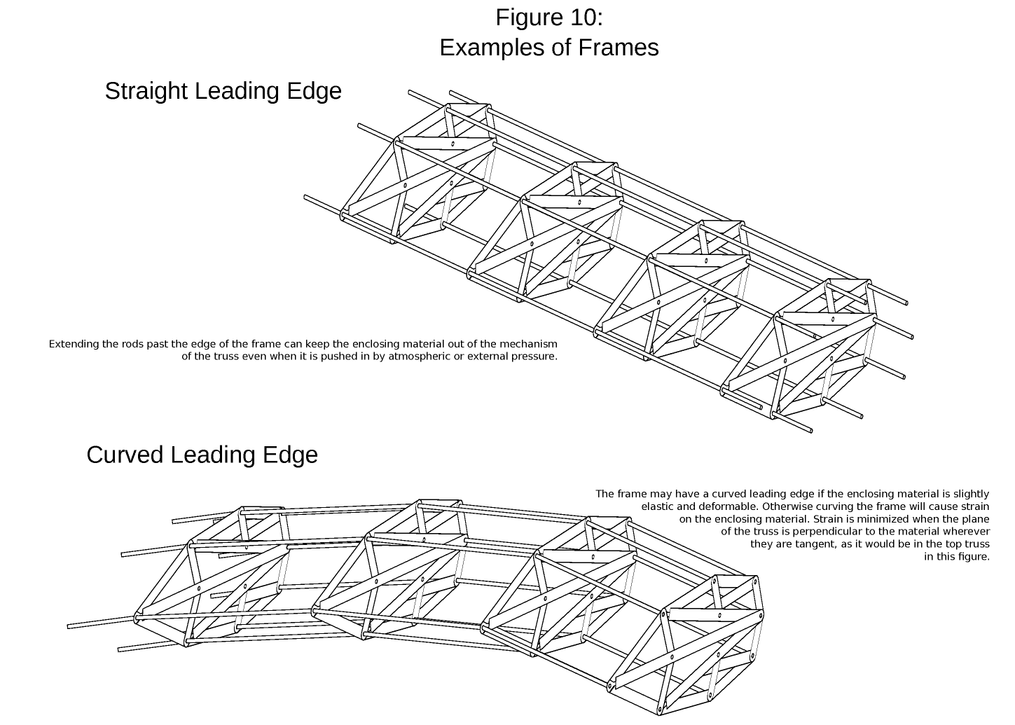

A full airfoil can be created by using a series of full trusses that are all identical and set parallel to each other as in FIG. 10, and covering all the trusses with a sheet of material impermeable to the medium the foil is intended to be used in, creating a polygonal prism structure that does not change its lateral surface area, but changes its volume. Here the sheet itself may be used to fix the length between vertices that may be attached by fixed-length flexible supports instead of solid segments, or it may be used in conjunction with fixed-length flexible supports or solid attachments.

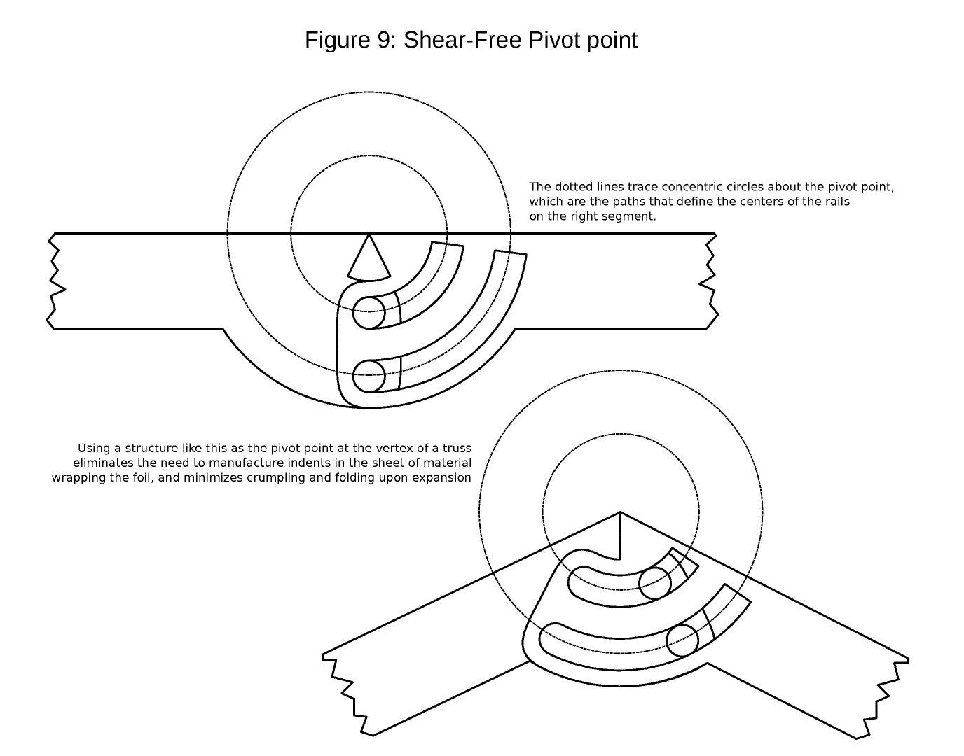

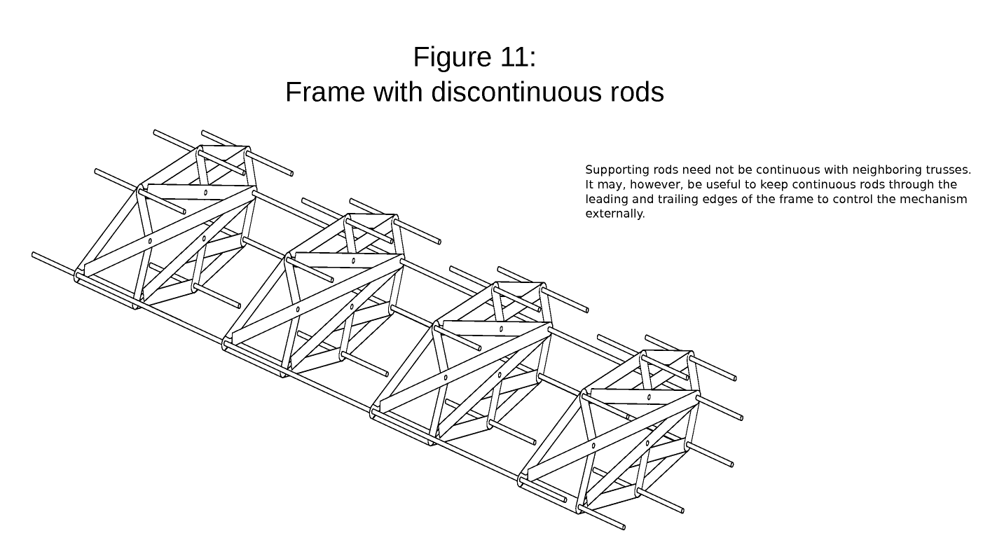

In order to ensure that the sheet does not change length at all, the truss must be designed so that the tangent plane of the sheet runs directly through the pivot points along the perimeter of the truss, and can rotate freely about that point. For the other pivoting structures in the truss, the plane of the sheet must also be able to rotate freely, but only about a point in the plane of the sheet. These conditions are illustrated in FIG. 7. As the figure shows, it is easily achievable by manufacturing an indent in the sheet of material. The more indents put in the material however, the more the distortion introduced upon expansion and contraction. This is why it is ideal to use either use bent segments to create the frame (also as shown in FIG. 7), and/or pivots that allow the edge of the pivoting object to run through the pivot point as shown in FIG. 9. Rods or plates, freely rotating or otherwise, may be affixed to the vertices of the truss or the segments to distribute pressure on the enclosing material. These rods may be continuous with neighboring trusses as in FIG. 10, or discontinuous as in FIG. 11. The material at the caps of the airfoil cannot shrink in surface area when the frame does, so these rods may also be extended past the edge of the airfoil to prevent the material from being caught in the mechanism, also as in FIGS. 9 and 10.

If there are rods fixed to the leading and trailing edges, and the rods are made to protrude through the material, and the material is sealed around the rods, it also provides a means of controlling the frame externally, since the position of the rods may be varied to change the shape of the frame. This is also shown in FIGS. 9 and 10.

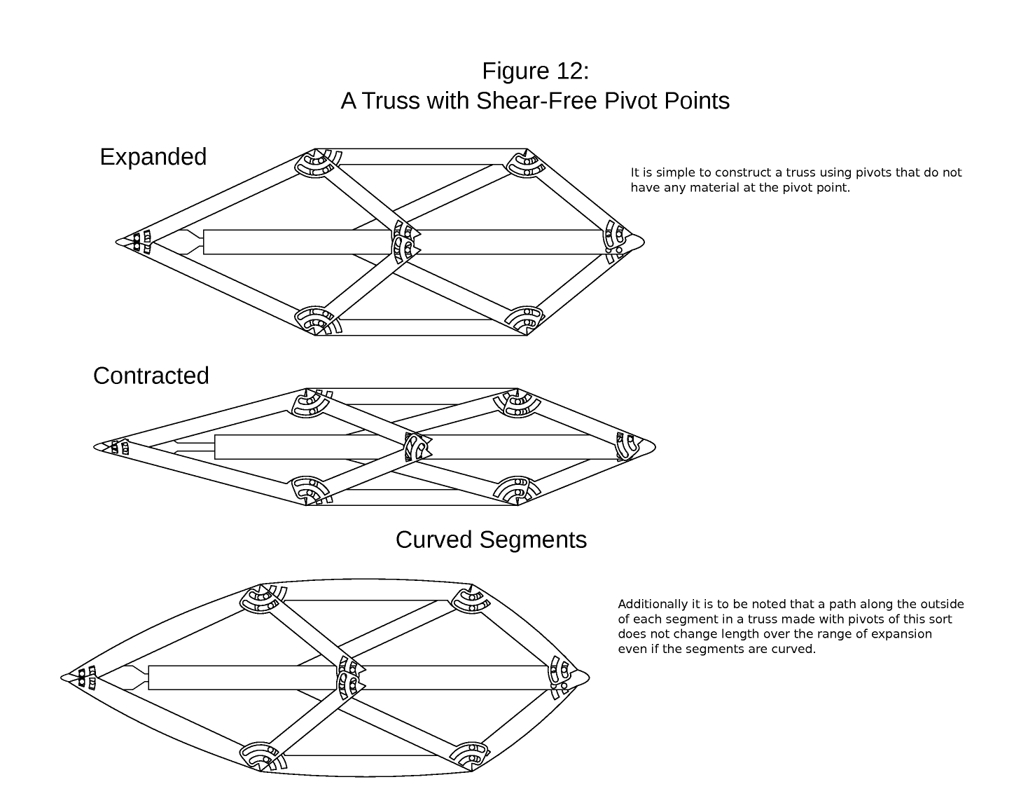

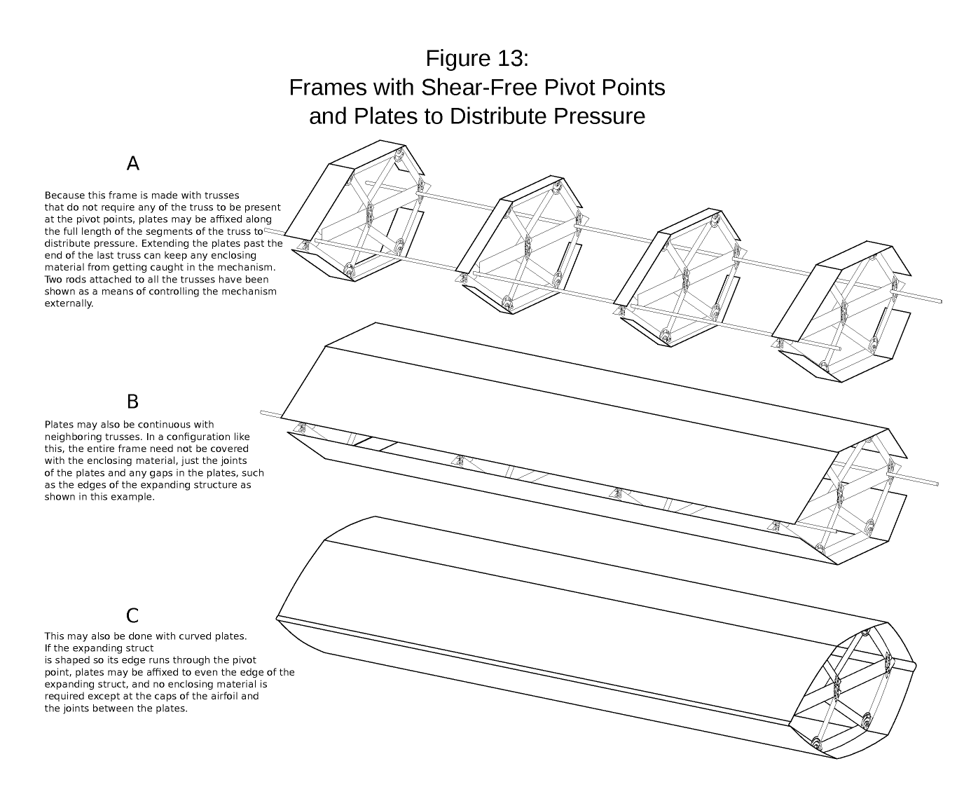

For trusses that use pivots that enable the edge of the pivoting object to run through the pivot point, the segments that make up the truss may have curved edges of any shape as long as they end at the pivot point, as shown in FIG. 12. This enables a better emulation of the desired airfoil cross section with less complexity in the truss. Additionally, for trusses with pivots of this type, plates may be affixed to the truss along the entire length of each segment, as shown in FIG. 13. These plates may be continuous or discontinuous with neighboring trusses.

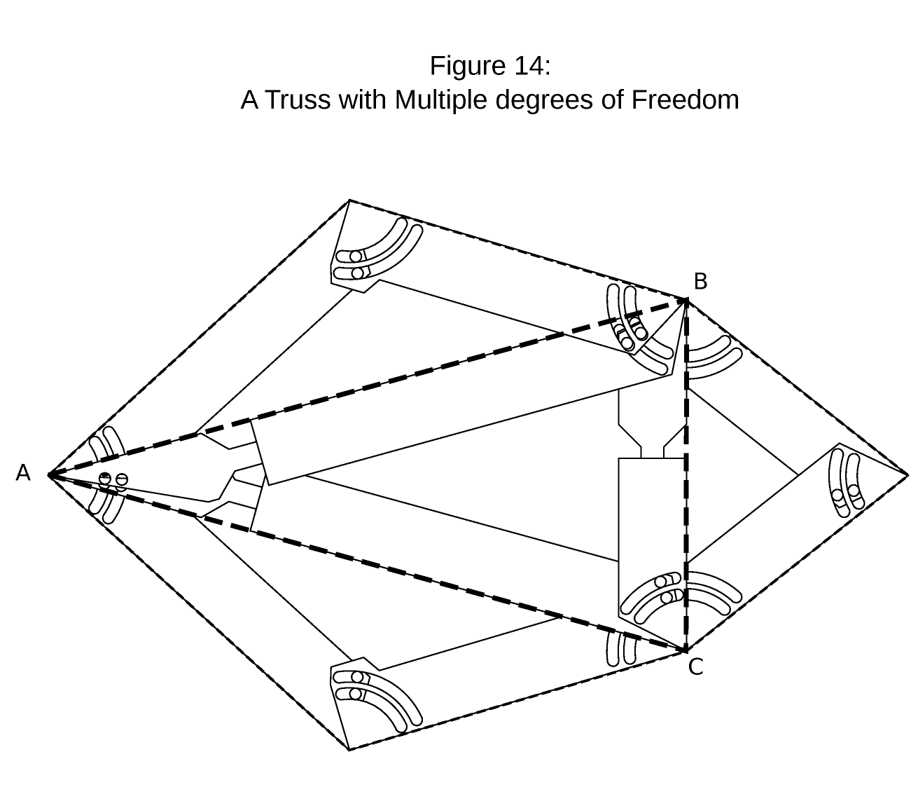

It is also possible to create a truss, and therefore a frame, with multiple degrees of freedom in its expansion. This may be accomplished by joining with pivots the ends of the expanding sides of any number of half trusses so that the pivots lie on the vertices of any simple polygon. An example of this is shown in FIG. 14. Any of the three vertices labeled A, B, and C may be moved and the structure will maintain a constant length around ifs outer edge. The bold dotted line shows the polygon created by the joined expanding sides (in this case a triangle). The thinner dotted line shows the unchanging perimeter of the structure. It is to be noted that in the example given in FIG. 14, the expandable struts connecting points A and B, B and C, and C and A are not strictly necessary since the half-trusses used are as in FIG. 5, I.

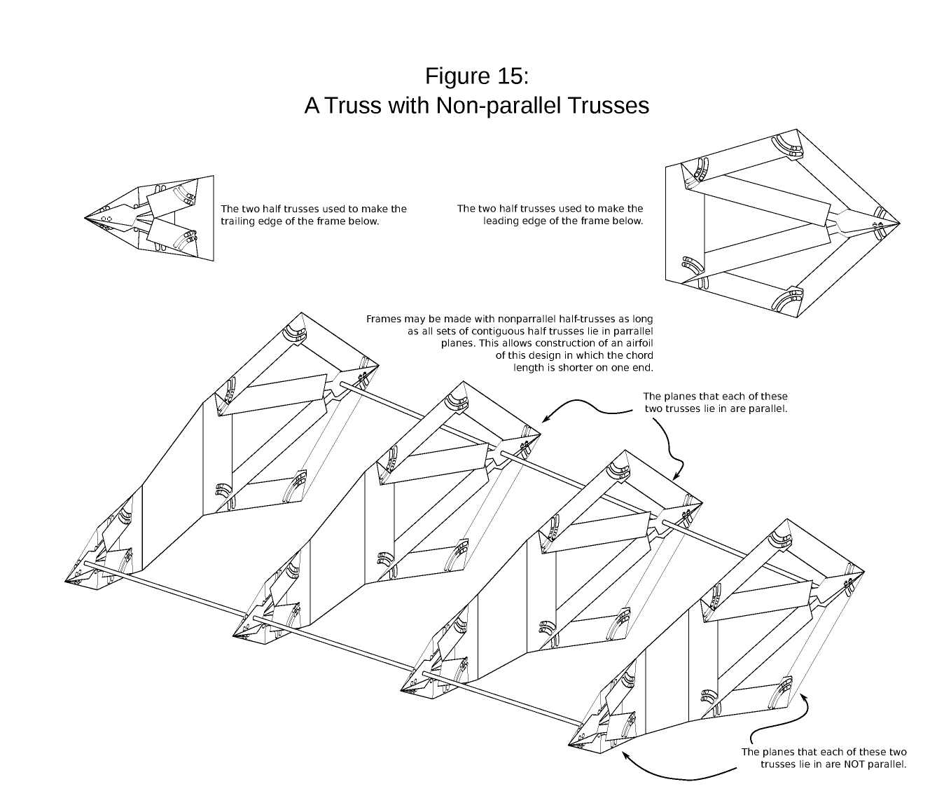

It is also possible to create a truss with multiple degrees of freedom by joining a series of half-trusses and rigid struts with pivots at their ends. When this is the case, non-contiguous half-trusses may actually be set so that the planes of their trusses are not parallel, shown in FIG. 15. The rigid struts need not necessarily lie within a plane to accommodate the different angles of non-contiguous half-trusses.

### DESCRIPTION OF RELATED DIAGRAMS IN RELATION TO FULL DESIGN

FIG. 1—Shows the simplest possible variant of an individual expanding truss in the frame of the design.

FIG. 2—Shows a simple variant of an individual expanding truss in the frame of the design.

FIG. 3—Shows a more complex variant of an individual expanding truss in the frame of the design. This is intended to demonstrate how the design may approximate the shape of an airfoil.

FIG. 4—Shows another complex variant of an individual expanding truss in the frame of the design. This illustrates how the design may be configured to alter its cross section in different ways.

FIG. 5—Illustrates just the top portions of different variants of individual expanding trusses. Each of the numbered trusses in FIG. 5 correspond to different sub-claims in claim I.

FIG. 6—Illustrates just the top portions of more possible variants of individual expanding trusses.

FIG. 7—Illustrates some of the ways the frame may reduce stress on an enclosing sheet.

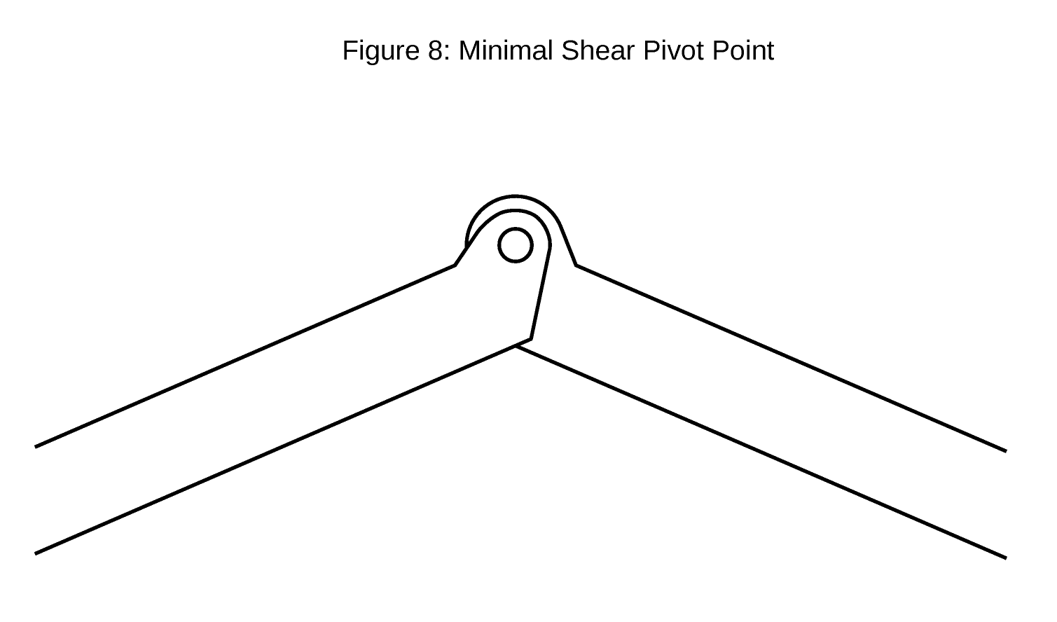

FIG. 8—Illustrates a possible pivot for use on a frame, which reduces shear on the enclosing sheet by preventing adjacent portions of the enclosing sheet from touching different moving parts.

FIG. 9—Illustrates a possible pivot for use on a frame, which applies no shear on an enclosing sheet at all.

FIG. 10—Shows a full frame, without an enclosing sheet, with both a straight leading edge and an approximately curved leading edge.

FIG. 11—Shows another full frame without an enclosing sheet, without continuous rods.

FIG. 12—Illustrates a fairly simple variant of an individual expanding truss, showing how shear-free pivots and curved segments may better approximate the desired airfoil cross-section with a simpler truss.

FIG. 13—Shows a full frame with shear-free pivot points, illustrating how such a frame may be covered with enclosing rigid plates instead of an enclosing sheet.

FIG. 14—Shows an individual truss in a frame with multiple degrees of freedom.

FIG. 15—Shows a full frame with non-parallel edges, without an enclosing sheet.

### DETAILED DESCRIPTION OF PREFERRED IMPLEMENTATION

Fixing each truss to expand by the same amount as the others may be accomplished as simply as having a single rod join the leading edges of the trusses and another rod joining the trailing edges of the trusses in every shared expandable strut present. The airfoil may also have a curved leading or trailing edge, but note that it is necessary for the enclosing material to have some elasticity to conform to the frame in this case. The rods joining the leading rails need only be curved to achieve this.

Since it is preferable to have the sheet of material around the airfoil frame wrinkle and fold as little as possible, it is best to construct the truss with the majority of the structure within the perimeter of the truss. Therefore the individual segments of each half truss may be constructed with a bent shape to ensure that the main body of the segment lies within the perimeter of the truss as in FIG. 7. This way, most of the enclosing sheet material may lie along the perimeter of the truss. The points of the material that lie above pivot points may be manufactured with small indents in them so as to wrap around the pivot points. The individual pivot points themselves may be created as in FIG. 8, such that the material of one individual segment is always further from the pivot point than the other segment, so that the sheet of material wrapping the foil is only in contact with one segment at the pivot point and is not subject to undue shear.

Alternatively, the individual segments themselves may be made to pivot about each other by a mechanism that has no material at the pivot point. An example of this is given in FIG. 9, consisting of rails that trace a portion of a circle about the pivot point. Only the very corner of this pivoting structure is actually at the point about which it pivots. Trusses built with this sort of pivot work very well in the sort of airfoil defined in claim 10, because built this way, no part of the mechanism extends beyond the boundary of the foil.

For larger aircraft, the practicality of giving the foil any significant bouyancy is lost, but building a foil as in claim 10 provides an extremely aerodynamic way to build a foil with a dynamically variable cross-section. This may have its own benefits during flight.

For a personal aircraft, the cheapest and most functional solution would be a foil as in claim 9, with plates affixed along the perimeter of the trusses in the foil, and the interior of the foil evacuated of all fluid. An evacuated foil in this design with a wingspan of 20 feet and a maximum chord length of 10 feet will easily provide more than 100 pounds of buoyant force.

What I claim is:

1. An expanding frame, henceforth referred to as simply a “frame,” whose vertices lie at the vertices of a polygonal prism, the lateral surface area of which does not change during expansion, consisting of a series of parallel planar expanding trusses which maintain a constant perimeter over the range of their expansion. Each planar expanding truss consists of two half-trusses constructed so as to share their expanding side. Each half-truss is constructed as in one of the sub-claims below. Each of the sub-claims corresponds to the corresponding sub-figure in FIG. 5.
I. An expandable strut along the expanding side, a rigid strut that can pivot about a position fixed with respect to one end of the expanding side, and another rigid strut that can pivot about both a position fixed with respect to the other end of the expanding side, and a position fixed with respect to the other rigid strut. This arrangement is such that the pivot points of the rigid struts with the expandable strut and the pivot point between the two rigid struts creates a triangle. Two of the sides of this triangle remain at constant length during expansion of the expandable strut, while the area of the triangle shrinks. This creates a half-truss as in half-truss I of FIG. 5.
II. A half-truss as in sub-claim I. with no expandable strut along the expanding side. This creates a half-truss as in half-truss II of FIG. 5.
III. An expandable strut along the expanding side, and two pairs of rigid struts both attached as the pair of rigid struts in sub-claim I, but at different points in relation to the expandable strut. Both pivot points that connect each pair of rigid struts are on the same side of the expanding axis of the expandable strut. This creates a half-truss as in half-truss III of FIG. 5, except without segment P. This structure may also undergo one of the following alterations:
a. An additional rigid strut may be attached between the pivot points that connect each pair of rigid struts. This corresponds to adding segment P in half-truss III of FIG. 5. The truss as described so far in sub-claim III did not have segment P.
b. A fixed-length flexible support such as a cable may be attached between the two pivot points that connect each pair of rigid struts. This corresponds to replacing segment P in half-truss III of FIG. 5 with a fixed-length flexible support.
c. A fixed-length flexible support such as a cable may be attached between the two pivot points that connect each pair of rigid struts, and then either of the rigid struts closer to the ends of the expandable strut may be removed, but not both. This corresponds to replacing segment P in half-truss III with a fixed-length flexible support and removing either segment A or B, but not both.
d. Either of the medial rigid struts, the ones towards the center of the expandable strut, may be removed, but not both. This corresponds to removing either segment R or S, but not both.
e. After attaching an additional rigid strut or flexible fixed length support between the two pivot points that connect each pair of rigid struts, both of the extrernal rigid struts, the ones towards the ends of the expandable strut, may be removed and replaced by flexible fixed length supports. This corresponds to adding segment P, and replacing both segments A and B with flexible fixed-length supports.
IV. As shown in FIG. 5, sub-figure IV. An expandable strut along the expanding side, with one or more pivot locations, with one pivot location mounted as close to the trailing edge of the expandable strut as possible. Each pivot location is either at the juncture of a pair of struts attached to the expandable strut as the pair of rigid struts in sub-claim I, or a single non-pivoting fixture with a pivot somewhere on its extremity. The pivot of the pivot location nearest the leading end of the expandable strut is connected to the leading end of the expandable strut by any of half trusses I, II, III, IV, V, VI, or VII, placed with their expanding edge between the pivot point and the end of the truss (denoted by Pₐ in FIG. 5 half-truss IV), and the constant-length portion of their perimeter facing outward. The pivot points of adjacent pivot locations are also connected by any of half trusses I, II, III, IV, V, VI, or VII (denoted by P_{b}, P_{c}, etc.).
V. As shown in FIG. 5, sub-figure V. An expandable strut along the expanding side, with one or more pivot locations as described in sub-claim IV, with one pivot location mounted as near to the leading edge of the expandable strut as possible. The pivot point of the pivot location nearest the trailing end of the expandable strut is connected to the trailing end of the expandable strut by any of half trusses I, II, III, IV, V, VI, or VII, placed with their expanding edge between the pivot point and the end of the truss, and the constant-length portion of their perimeter facing outward (denoted by Pₐ in FIG. 5 half-truss V). The pivot points of adjacent pivot locations are also connected by any of half trusses I, II, III, IV, V, VI, or VII (denoted by P_{b}, P_{c}, etc.).
VI. As shown in FIG. 5 half truss VI. An expandable strut along the expanding side, with two or more pivot locations as described in sub-claim IV, with one pivot location mounted as near to the leading edge of the expandable strut as possible, and one other pivot location mounted as near to the trailing edge of the expandable strut as possible. The pivot points of adjacent pivot locations are also connected by any of half trusses I, II, III, IV, V, VI, or VII (denoted by Pₐ, P_{b}, P_{c}, etc. in FIG. 5 half-truss VI). This is done as shown in FIG. 5 half truss VI.
VII. An expandable strut along the expanding side with at least one pivot location as described in sub-claim IV, and no pivot location mounted as close as possible to either end of the expandable strut. The pivot location nearest to the leading edge of the expandable strut is connected to the leading edge by any of half trusses I, II, III, IV, IV, V, VI, or VII (denoted by P_{b}). The pivot location nearest to the trailing edge of the expandable strut is connected to the trailing edge by any of half trusses I, II, III, IV, IV, V, VI, or VII (denoted by Pₐ). The pivot points of adjacent pivot locations are also connected by any of half trusses I, II, III, IV, V, VI, or VII.

2. A structure that maintains a constant perimeter through all of its pivot points except for one expanding side, as in any of the half-trusses described in claim 1 sub-claims III-VII.

3. A frame with multiple degrees of freedom consisting of a series of parallel planar expanding trusses or rigid struts which maintain a constant perimeter over the range of their expansion. The trusses consist of any number of half-trusses as in claim 1, sub-claims I-VII, linked end to end with pivots such that the expanding sides of the half trusses and the rigid struts are in the shape of any simple polygon, as shown in FIG. 14.

4. A frame as in claim 3, planes of half-trusses separated by a rigid strut are not necessarily parallel to each other. This shown in FIG. 15.

5. An airfoil consisting of a frame as in claim 1, 3 or 4, enclosed in a sheath of flexible material impervious to the medium in which the foil is intended to be used in, such that the sheath of material prevents any of the surrounding medium from entering the frame.

6. An airfoil as in claim 5, with the enclosed space formed by the sheath of material around the frame evacuated of all fluids to form a vacuum.

7. An airfoil as in claim 5, with the enclosed space formed by the sheath of material around the frame filled with a compressible fluid of desired density.

8. An airfoil as in claim 5, where the sheath of material does not completely surround the frame, leaving the inside exposed to the medium surrounding the foil.

9. An airfoil as in any of claims 5, 6, 7 and 8 with additional struts or plates mounted to the perimeter of the frame to help support the sheath of material. This is shown in FIGS. 7, 10, 11 and 13.

10. An airfoil as in claim 5 with plates fixed to the entire perimeter of the individual trusses, such that the plates attached to one truss are continuous with the plates attached to adjacent trusses, and no enclosing sheath of material. This is shown in FIG. 13C.

11. An airfoil as in claim 10 with a material impervious to the medium the foil is intended to be used in used to seal the joints between plates and the caps of the airfoil, such that none of the surrounding medium may enter the foil.

12. An airfoil as in claim 11 where the plates attached to one truss are not necessarily entirely continuous with adjacent trusses.
